(19) United States
(12) Patent Application Publication
(10) Pub. No.: US 2005/0032562 A1
(43) Pub. Date: Feb. 10, 2005

(54) Game machine and storage medium having game program stored therein

(75) Inventors: Toru Osawa, Kyoto-shi (JP); Yasutaka Takeuchi, Kyoto-shi (JP)

Correspondence Address: NIXON & VANDERHYE, P.C., 1100 N. GLEBE ROAD, 8TH FLOOR, ARLINGTON, VA, 22201, US

(73) Assignee: NINTENDO CO., LTD., Kyoto (JP)

(21) Appl. No.: 10/901,088

(22) Filed: Jul. 29, 2004

(30) Foreign Application Priority Data
Aug. 6, 2003 (JP) 2003-288036

(51) Int. Cl. A63F 13/00

(52) U.S. Cl. 463/3

(57) ABSTRACT

In a game machine and a storage medium having a game program stored therein of the present invention, the concept of audience's voltage is introduced as the state of a third party into a competitive sports game in a virtual game space. The third party is differentiated from the athletes of both teams, i.e., the subjects of the competitive sports game. The relationship between the athletes and audience is allowed to be involved in the development of the game. By increasing the audience's voltage, a player of the game machine is allowed to play a different game (i.e., a bonus game), which will with a high probability result in granting the player an advantage in the game. Thus, the enjoyment arising from playing the competitive game is enhanced.

### BACKGROUND OF THE INVENTION

1. Field of the Invention

The present invention relates to a game machine and a storage medium having a game program stored therein. More specifically, the present invention relates to a game machine and a storage medium having a game program stored therein for realizing a game (e.g., a competitive game) that a player plays by operating “objects” and which is capable of producing enhanced excitement in the player by allowing the state of a third party (e.g., an audience), which is different from the “objects” of two sides participating in the competitive game (i.e., the subjects of the competitive game), to affect development of the game.

2. Description of the Background Art

Various competitive sports games (e.g., soccer games and baseball games) in which actual sports are simulated on computers or game machines for home use are already known. In such a game, players (i.e., game players) can enjoy game playing by operating contestant (athlete) “objects” participating in a competitive game simulated in the game space, thereby competing with other players to become a winner in the competitive game. In the case of a baseball game, for example, a player operating an offensive team tries to control his or her athlete object to make a hit as a batter. If the athlete object successfully makes a hit, then in turn the player operates the athlete object so as to score a run as a runner. On the other hand, a player operating a defensive team operates his or her athlete object serving as a pitcher so as to pitch a strike. If an opponent athlete object bats the pitched ball, the player operates his or her athlete objects serving as fielders so as to catch the batted ball and put out the opponent athlete object.

In many cases, degrees of abilities are individually set for each athlete object which is to participate in a sports game that takes place in a game space. Each athlete object's degrees of abilities are to be set in accordance with the kind of sports game. For example, power (destructive power), agility, physical strength (endurance), jumping power, and the like of athletes may be set. In the case of a baseball game, even if the player performs the same operation, an athlete having a greater power will be able to send a ball flying farther; an athlete having a greater agility will be able to run at a higher speed between bases; an athlete having a greater physical strength will be able to show stable performance in pitching more innings; an athlete having a greater jumping power will be able to jump higher to catch a batted ball traveling over his or her head; and so on.

For example, as is disclosed in Japanese Laid-Open Patent Publication No. 11-342263, there is a sports game in which such degrees of abilities of athletes are allowed to change. The enjoyment arising from playing this sports game is enhanced because the degrees of abilities of athletes are allowed to increase or decrease based on the motivation indices of the athletes operated by players. As is disclosed in Japanese Laid-Open Patent Publication No. 2002-320775, for example, there is a game in which the enjoyment arising from playing the game is enhanced because the degrees of abilities of athletes are allowed to increase or decrease based on the morale of each team. If the morale of a team rises, the degrees of abilities of athletes belonging to that team become higher, and the athletes of the team become able to perform with the improved abilities. Further, as is disclosed in the specification of Japanese Patent No. 3207401, for example, there is a game in which the enjoyment arising from playing the game is enhanced because the degrees of abilities of athletes are allowed to increase or decrease based on the morale of each team, which further affects the athletes' meet rates or defense rates which define their skill in batting and fielding, respectively.

On the other hand, in actual sports games, a large audience and/or supporters (i.e., cheering parties) function as an important factor in making the games exciting. In an actual game, the audience and supporters become delighted or depressed, i.e., their degree of excitement changes, depending on the athletes' performances and the development of the game. In addition, it often happens that cheers from the audience and/or supporters affect the psychological states of the athletes, which in turn may affect their performances. For example, the abilities of athletes may improve as the sound volume level of the cheers (voltage) of the audience and/or supporters increases. On the contrary, the abilities of athletes may decline as the athletes become nervous hearing the cheers.

In conventional sports games, however, it is only by changing the degrees of abilities of athletes that the enjoyment of playing the games is enhanced. Specifically, the relationship of the athletes to the audience and/or supporters (who are seeing virtual sports games in game spaces) has never been introduced into the games as an important factor of the games. Further, in conventional sports games, the primary object of a game is to score points and thereby achieve a victory in the game. In other words, in a conventional sports game, it is not required that the athletes should try to entertain the audience and supporters in the manner of an actual sports game. That is to say, in a game in conventional sports games, the audience is no more than a third party; the performances of athletes' and the developments of games have no effect on the audience; and the audience has no influence on the athletes.

### SUMMARY OF THE INVENTION

Therefore, an object of the present invention is to provide a game machine and a storage medium having a game program stored therein, the enjoyment of which can be enhanced by allowing the state of a third party, as differentiated from both sets of objects participating in a competitive game (i.e., the subjects of a competitive game in a virtual game space), to affect development of the game. More specifically, an object of the present invention is to provide a game machine and a storage medium having a game program stored therein, the enjoyment of which can be enhanced by giving a privilege to one team if the voltage of a third party supporting that team increases so much as to overwhelm the voltage of a third party supporting the other team while a competitive sports game is being played.

The present invention has the following features to achieve the object above. Reference numerals and the like within parentheses are provided only for showing the connections to the best mode described further below to make the present invention easily understood, and does not restrict the scope of the present invention in any manner.

A game machine (3) of the present invention expresses, on a game screen, a competitive game played between character objects which are divided in to two sides. The game machine includes operation means (a controller 6), a game processing means (a CPU 30 performing step S5; hereinafter only step numbers are shown), action point storage means (audience excitement factor increase/decrease data stored in a data storage area 332), third party's state calculation means (S6), and game presenting means (S7, S8). The operation means inputs operation data in response to an operation by a player of the game machine (S4). The game processing means processes the competitive game by allowing a character object (objects 21, 22) participating in the competitive game to make actions in response to the operation data inputted from the operation means. The action point storage means stores a number of points (VP) which is set with respect to each action of the character object and which indicates a degree to which a state of at least one of a plurality of third parties (audience excitement factor V) is affected when the action is made by the character object, the affected third party being associated with one of the two sides participating in the competitive game, and the plurality of third parties being different from the character objects participating in the competitive game. The third party's state calculation means, in accordance with an action of the character object as controlled by the game processing means (S61), reads from the action point storage means the number of points for the action (S62) and calculates, based on the number of points, a new state of the affected third party and a new state of a further third party associated with the other of the two sides participating in the competitive game (S64, S65). If the state of either third party reaches a predetermined value (100) (S7), the game presenting means presents a further game (a bonus game), the further game being exclusive to a player operating the side associated with the third party.

The game machine may include gauge generation means (S66) and display control means (a GPU 32, S5, S66). The gauge generation means generates a gauge (a voltage gauge 23) for indicating the states of the third parties associated with the two sides participating in the competitive game, the states of the third parties having been processed by the third party's state calculation means. The display control means controls a display of a game image (20) including the gauge generated by the gauge generation means, based on a result of processing of the competitive game by the game processing means. For example, the gauge generation means generates the gauge so that an entire area of the gauge is divided into two areas (231, 232), each area corresponding to the state of the third party associated with a different one of the two sides. If the state of either third party reaches the predetermined value, the entire area of the gauge becomes the area corresponding to the state of the third party.

Specifically, the competitive game expressed on the game screen may be a virtual competitive sports game. In this case, the character objects comprise athlete objects belonging to one of the two sides (a player's team) participating in the competitive sports game, and athlete objects belonging to the other of the two sides (an opponent team). The states of the third parties associated with the two sides participating in the competitive game comprise an audience excitement factor (V1) for the one side and an audience excitement factor (V2) for the other side. If the audience excitement factor for the one side reaches or exceeds the predetermined value (voltage), the game presenting means presents the further game, the further game being exclusive to a player operating the athlete objects belonging to the one side.

The game machine may further include excitement factor initial value storage means (audience excitement factor initial value data stored in the data storage area 332). The excitement factor initial value storage means stores an initial value (I) of the audience excitement factor for at least one of the two sides, the initial value being set dependent on a virtual playing field (place) on which the competitive sports game is held. The action point storage means stores: a number of points (+VP) by which the audience excitement factor is increasable and which is associated with an action of the athlete object that produces an advantageous effect to one of the two sides to which the athlete object belongs in the competitive sports game (a point increasing action); and a number of points (−VP) by which the audience excitement factor is decreasable and which is associated with an action of the athlete object that produces a disadvantageous effect to one of the two sides to which the athlete object belongs in the competitive sports game (a point decreasing action). In this case, in accordance with an action of the athlete object as processed by the game processing means, the third party's state calculation means calculates the audience excitement factor through cumulatively making an addition or reduction of the number of points stored in the action point storage means to or from the initial value of the audience excitement factor stored in the excitement factor initial value storage means (S64, S65).

For example, the further game executed by the game presenting means is a bonus game for determining a manner in which at least one of a plurality of ability values (player object ability data) each defining skill of the athlete object participating in the competitive sports game is updated (S81, S82). In this case, the game processing means processes the competitive sports game in response to the operation data inputted from the operation means, while controlling the athlete object so as to act with a performance level corresponding to the at least one ability value as updated as a result of the bonus game (S86). The bonus game may be a game in which the at least one ability value of an athlete object belonging to one of the two sides that is entitled to playing the bonus game will increase with a high probability (the probability corresponds to the extents of areas 241 to 244). The game machine may further include bonus-effective period setting means (S10, S11). The bonus-effective period setting means sets an effective period during which the at least one ability value as updated is kept effective by the game processing means. In this case, if the effective period set by the bonus-effective period setting means has elapsed, the game processing means restores the at least one ability value to the value before the update (S12), whereafter the athlete object comes to be controlled so as to act with a performance level corresponding to the at least one ability value as restored.

A game program stored in a storage medium of the present invention realizes a competitive game played between character objects which are divided into two sides, by being executed by a computer (a CPU 30) in a game machine including operation means for inputting operation data in response to an operation by a player of the game machine and storage means for temporarily storing data (a main memory 33). The storage means stores a number of points (audience excitement factor increase/decrease data stored in the data storage area 332) which is set with respect to each action of a character object participating in the competitive game and which indicates a degree to which a state of at least one of a plurality of third parties is affected when the action is made by the character object, the affected third party being associated with one of the two sides participating in the competitive game, and the plurality of third parties being different from the character objects participating in the competitive game. The game program stored in the storage medium causes the computer to perform a game processing step (S5), a third party's state calculation step (S6), and a game presenting step (S7, S8). The game processing step processes the competitive game by allowing a character object participating in the competitive game to make actions in response to the operation data inputted from the operation means. In accordance with an action of the character object as controlled by the game processing step, the third party's state calculation step reads from the storage means the number of points for the action and calculates, based on the number of points, a new state of the affected third party and a new state of a further third party associated with the other of the two sides participating in the competitive game. If the state of either third party reaches a predetermined value, the game presenting step presents a further game, the further game being exclusive to a player operating the side associated with the third party.

The game program stored in the storage medium may further cause the computer to perform a gauge generation step (S66) and a display control step (S5, S66). The gauge generation step generates a gauge for indicating the states of the third parties associated with the two sides participating in the competitive game, the states of the third parties having been processed by the third party's state calculation step. The display control step controls a display of a game image including the gauge generated by the gauge generation step, based on a result of processing of the competitive game by the game processing step. For example, the gauge generation step generates the gauge so that an entire area of the gauge is divided into two areas, each area corresponding to the state of the third party associated with a different one of the two sides. If the state of either third party reaches the predetermined value, the entire area of the gauge becomes the area corresponding to the state of the third party.

Specifically, the competitive game expressed on the game screen may be a virtual competitive sports game. In this case, the character objects comprise athlete objects belonging to one of the two sides participating in the competitive sports game, and athlete objects belonging to the other of the two sides. The states of the third parties associated with the two sides participating in the competitive game comprise an audience excitement factor for the one side and an audience excitement factor for the other side. If the audience excitement factor for the one side reaches or exceeds the predetermined value, the game presenting step presents the further game, the further game being exclusive to a player operating the athlete objects belonging to the one side.

The storage means may further store an initial value of the audience excitement factor for at least one of the two sides (audience excitement factor initial value data stored in the data storage area 332), the initial value being set dependent on a virtual playing field on which the competitive sports game is held. As the number of points, the storage means may store a number of points by which the audience excitement factor is increasable and which is associated with an action of the athlete object that produces an advantageous effect to one of the two sides to which the athlete object belongs in the competitive sports game, and a number of points by which the audience excitement factor is decreasable and which is associated with an action of the athlete object that produces a disadvantageous effect to one of the two sides to which the athlete object belongs in the competitive sports game. In this case, in accordance with an action of the athlete object as processed by the game processing step, the third party's state calculation step calculates the audience excitement factor through cumulatively making an addition or reduction of the number of points stored in the storage means to or from the initial value of the audience excitement factor stored in the storage means.

For example, the further game executed by the game presenting step is a bonus game for determining a manner in which at least one of a plurality of ability values each defining skill of the athlete object participating in the competitive sports game is updated. In this case, the game processing step processes the competitive sports game in response to the operation data inputted from the operation means, while controlling the athlete object so as to act with a performance level corresponding to the at least one ability value as updated as a result of the bonus game. The bonus game may be a game in which the at least one ability value of an athlete object belonging to one of the two sides that is entitled to playing the bonus game will increase with a high probability. The game program may further cause the computer to perform a bonus-effective period setting step (S10, S11). The bonus-effective period setting step sets an effective period during which the at least one ability value as updated is kept effective by the game processing step. In this case, if the effective period set by the bonus-effective period setting step has elapsed, the game processing step restores the at least one ability value to the value before the update, whereafter the athlete object comes to be controlled so as to act with a performance level corresponding to the at least one ability value as restored.

A game machine according to the present invention realizes game playing in which the enjoyment arising from the game playing is enhanced by allowing the state of a third party, which is different from the “objects” of both sides (i.e., the subjects of the competitive game in a virtual game space), to affect development of the game. Specifically, there is realized a competitive game in which the relationship between the “objects” and the third party is allowed to be involved in the development of the competitive game and in which a player may be allowed to play a further game as a reward by changing the state of the third party. Thus, there are provided a game machine and a game program for realizing a competitive game in which the enjoyment arising from game playing is further enhanced.

In the case where the game machine includes a gauge generation means, the change of the state of the third party is capable of being conveyed to a player while the competitive game is being played. Thus, game playing with enhanced enjoyment is achieved. Moreover, in the case where a gauge generated by the gauge generation means is a type of gauge in which the entire area of the gauge is divided into two areas, each area corresponding to the state of the third party associated with a different one of the two sides, the fluctuating change of the state of the third party becomes capable of being conveyed to the player. At a moment when either of two players acquires the right to play the further game, the entire area of the gauge for displaying the state of the third party for each side becomes occupied by the area corresponding to the side of that player. This produces an impression that the state of the third party associated with the other side has become completely overwhelmed. As a result, game playing producing enhanced enjoyment is provided.

In the case where the competitive game is a competitive sports game (e.g., a baseball game or a soccer game) in which athlete objects participate and where the state of the third party comprises an audience excitement factor for one side and an audience excitement factor for the other side, the state of the third party can be expressed as the voltage of audience (an audience excitement factor). Accordingly, there is realized a game development in which the relationship of athletes to audience is an important factor therefor. Thus, it becomes possible that a player is allowed to play the further game by increasing the voltage of the audience. As a result, there are provided a game machine and a game program for realizing a competitive game in which the enjoyment arising from game playing is further enhanced.

In addition, in the case where the game machine is provided with an excitement factor initial value storage means, the setting as to whether the competitive game is a “home game” or an “away game” for the respective sides becomes capable of being introduced into the game, simulating an actual baseball game, soccer game, or the like. For example, assuming that the competitive game is a “home game” for the one side, the audience excitement factor associated with the side may initially be set high. As a result, game playing with enhanced enjoyment is provided. A number of points by which the audience excitement factor is increasable and which is associated with an action of an athlete object that produces an advantageous effect to one of the two sides to which the athlete object belongs in the competitive sports game may be introduced into the game. The introduction thereof will make it possible to simulate that situation occasionally occurring in actual games, i.e., the situation in which the excitement of audience grows in response to the actions of athletes.

In the case where the further game is a bonus game in which the result thereof affects the ability value of an athlete object, the objective of playing the further game becomes definite because the competitive sports game and the further game is closely related with each other. In addition, in the case where the further game is a kind of game that, more likely than not, produces an advantageous effect to a player who plays the further game in the competitive sports game, a player is capable of acquiring an advantage in the competitive sports game by increasing the voltage of the audience. As a result, a competitive sports game with enhanced enjoyment is provided. Further, in the case where the game machine is provided with a bonus-effective period setting means, the period during which the advantage acquired by playing the bonus game is kept effective can be limited. Therefore, the player is capable of enjoying game playing during that period, regarding it as a special period.

The present invention may be realized as a storage medium storing a game program to be executed by a computer in a game machine. Also in this case, the above-described advantages of the present invention are achieved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outer view illustrating a game system 1 according to an embodiment of the present invention;

FIG. 2 is a functional block diagram of a game machine 3 shown in FIG. 1;

FIG. 3 is a schematic memory map illustrating exemplary programs and data to be stored in a main memory 33 shown in FIG. 2;

FIG. 4 is a diagram showing audience excitement factor increase/decrease data stored in a data storage area 332 shown in FIG. 3, a baseball game being illustrated as an exemplary competitive sports game;

FIG. 5 is a diagram showing exemplary audience excitement factor initial value data stored in the data storage area 332 shown in FIG. 3;

FIG. 6 is a diagram showing exemplary audience supporting power data stored in the data storage area 332 shown in FIG. 3;

FIG. 7 is a diagram showing exemplary player object ability data and bonus game setting data stored in the data storage area 332 shown in FIG. 3;

FIG. 8 is a flowchart illustrating the entire process for a competitive sports game that is executed by the game machine 3 shown in FIG. 1;

FIG. 9 is a subroutine showing the detailed operation of step S6 in FIG. 8;

FIG. 10 is a subroutine showing the detailed operation of step S8 in FIG. 8;

FIG. 11 is an exemplary game image 20a displayed on a monitor 2 shown in FIG. 1;

FIG. 12 is an enlarged illustration of a voltage gauge 23 to be displayed in the game image 20a of FIG. 11; and

FIG. 13 is an exemplary image of a roulette game, which is displayed on the monitor 2 shown in FIG. 1 as a game image 20b at the time of a bonus game.

### DESCRIPTION OF THE PREFERRED EMBODIMENTS

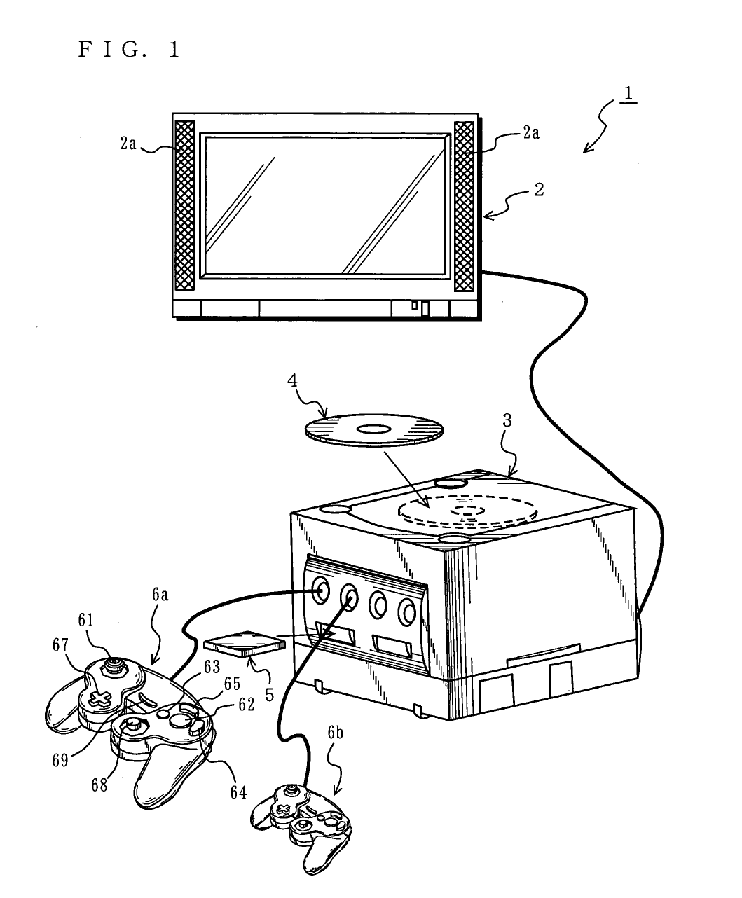

With reference to FIG. 1, a game system 1 according to an embodiment of the present invention is described. FIG. 1 is an outer view illustrating the game system. The game system 1 of the present invention is described below, taking a non-handheld type game machine as an example of a game machine.

As shown in FIG. 1, the game system 1 is composed of a television receiver for home use or the like including a loudspeaker 2a and a CRT (Cathode Ray Tube) display (hereinafter referred to as a “monitor”) 2, and a non-handheld type game machine (hereinafter referred to simply as a “game machine”) 3, which is connected to the television receiver or the like via a connecting cord. The game machine 3 includes a controller 6 (connected to the game machine 3 via a connecting cord) and an optical disk 4, which is an example of an information storage medium that can be interchangeably used for the game machine 3. Moreover, an external memory card 5 mounted with a backup memory or the like for stably storing so-called save data and/or the like is inserted into the game machine 3 so as to be capable of being detached when necessary. The game machine 3 executes a game program stored in the optical disk 4 and displays a game image on the monitor 2 based on the game program. Furthermore, by utilizing the “save data” stored in the external memory card 5, the game machine 3 is capable of reproducing a situation into which a game had progressed at a point in the past and displaying a corresponding game image on the monitor 2. Then, a player of the game machine 3 can enjoy further game progression by operating the controller 6 seeing the game image displayed on the monitor 2. In the case where a game is played by a plurality of players, the players can enjoy game progression by operating one of a plurality of controllers 6 while seeing a game imaged is played on the monitor 2. Note that FIG. 1 illustrates an exemplary case where two players each operate one of the controllers 6a and 6b. In the following descriptions, the controllers 6a and 6b are collectively referred to as “controllers 6”. The following descriptions illustrate an exemplary case where a sports game program stored in the optical disk 4 is executed.

The controllers 6 are connected to the game machine 3 via connecting cords. The connecting cords are detachable from the game machine 3. The controllers 6 are operation means for mainly operating player objects (typically, athlete objects playing a sport, which are operated by the players) that appear in a game space displayed on the monitor 2. The controllers 6 are each provided with input portions such as a plurality of operation buttons, a key, a stick, and the like. Specifically, grip portions, which are to be gripped by a player, are formed in each controller 6. Each controller 6 includes: a main stick 61 and a cross key 67, which are capable of being operated with the thumb of the left hand or the like; a C stick 68, an A button 62, a B button 63, an X button 64, a Y button 65, which are capable of being operated with the thumb of the right hand or the like; and a start/pause button 69. Moreover, each controller 6 includes an R button 66a and an L button 66b, which are capable of being operated with, for example, the index fingers of the right and left hand, respectively, of a player. Note that these input portions are used in the course of the development of the game. However, because the input portions have no direct connection to the description of the present invention, detailed descriptions of the input portions are omitted.

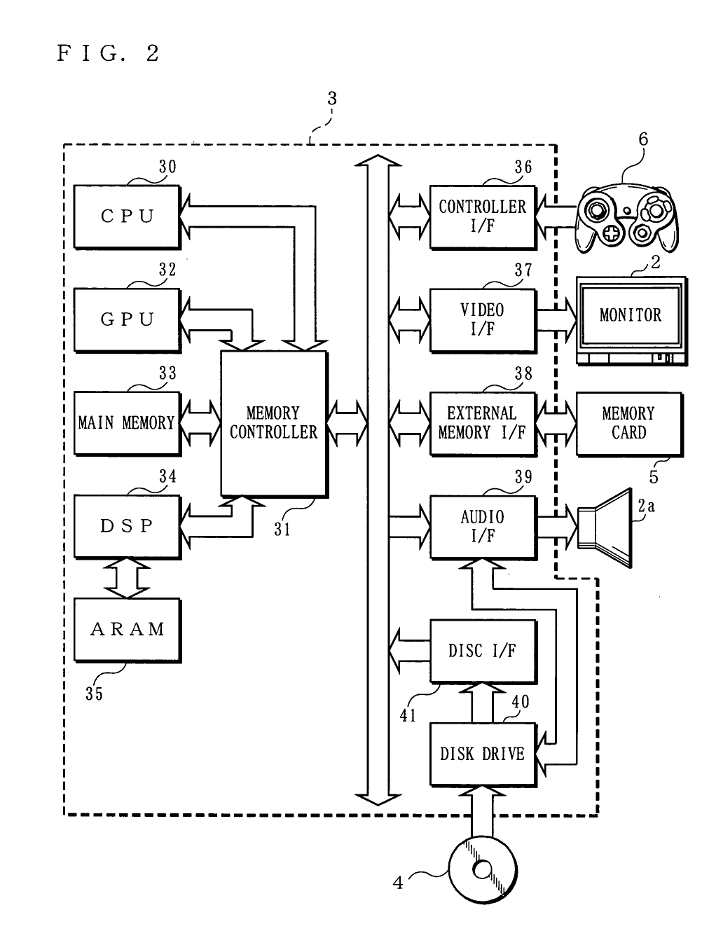

Next, with reference to FIG. 2, the configuration of the game machine 3 is described. FIG. 2 is a functional block diagram of the game machine 3.

As shown in FIG. 2, the game machine 3 includes a CPU (Central Processing Unit) 30 for executing various programs, e.g., a RISC CPU. The CPU 30 executes a starting program stored in a Boot Rom (not shown). After performing the initialization of the main memory 33 and/or other processes, the CPU 30 executes a game program stored in the optical disk 4. Then, the CPU 30 performs a game processing in accordance with the game program. To the CPU 30 are connected a GPU (Graphics Processing Unit) 32, a main memory 33, a DSP (Digital Signal Processor) 34, and an ARAM (Audio RAM) 35 via a memory controller 31. To the memory controller 31 are connected a controller I/F (interface) 36, a video I/F 37, an external memory I/F 38, an audio I/F 39, and a disk I/F 41 via a predetermined bus, to which in turn are connected, respectively, a controller 6, a monitor 2, an external memory card 5, a loudspeaker 2a, and a disk drive 40.

The GPU 32 performs image processing based on instructions from the CPU 30. For example, the GPU 32 is composed of a semiconductor chip which performs computation processes necessary for displaying 3D graphics. The GPU 32 performs image processing by utilizing a memory (not shown) dedicated to image processing and/or part of the storage area in the main memory 33. Thus, the GPU 32 generates a game image to be displayed on the monitor 2, and outputs the generated game image to the monitor 2 via the memory controller 31 and the video I/F 37 when necessary.

The main memory 33 is a storage area used by the CPU 30 and stores, as necessary, a game program and the like which is necessary for the processes to be performed by the CPU 30. For example, the main memory 33 stores a game program, various data, and the like which are read by the CPU 30 from the optical disk 4. The game program, various data, and the like stored in the main memory 33 are executed by the CPU 30.

The DSP 34 processes sound data and the like generated by the CPU 30 when executing a game program. The ARAM 35 for storing sound data and the like is connected to the DSP 34. The ARAM 35 is used when the DSP 34 performs a predetermined process (e.g., the storage of look-ahead part of the game program or look-ahead sound data). The DSP 34 reads the sound data stored in the ARAM 35 and outputs the sound data to the loudspeaker 2a, included in the monitor 2, via the memory controller 31 and the audio I/F 39.

The memory controller 31 exercises general control over data transfer. The aforementioned various I/Fs are connected to the memory controller 31. For example, the controller I/F 36 may be composed of four controller I/Fs 36a, 36b, 36c, and 36d. By using connectors provided to the controller I/Fs 36a to 36d, connectable external devices may be connected to the game machine 3 so that the external devices and the game machine 3 are capable of communicating with each other. For example, the controllers 6 may each be fitted into one of the connectors via a connecting cord, and then connected to the game machine 3 via the controller I/F 36. The monitor 2 may be connected to the video I/F 37. The external memory card 5 may be connected to the external memory I/F 38, whereby the backup memory provided in the external memory card 5 will become capable of being accessed from the CPU 30. The loudspeaker 2a provided on the monitor 2 may be connected to the audio I/F 39, whereby the loudspeaker 2a will be capable of outputting sound data which the DSP 34 reads from the ARAM 35 and sound data which is directly outputted from a disk drive 40. The disk drive 40 may be connected to the disk I/F 41. The disk drive 40 reads data stored in an optical disk 4 which is placed at a predetermined read position, and outputs the read data to a bus of the game machine 3 and/or the audio I/F 39.

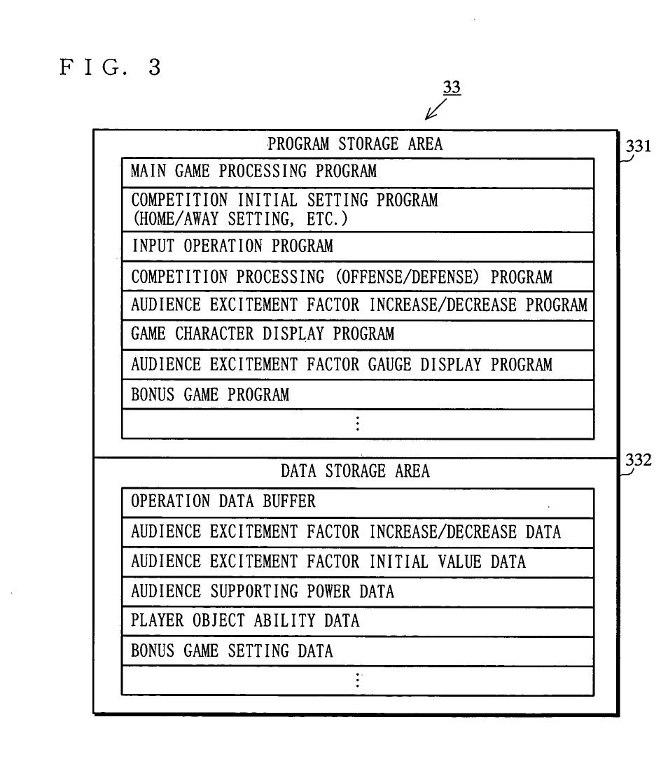

As described before, the main memory 33 stores, as necessary, a game program and the like necessary for the processes to be performed by the CPU 30. The main memory 33 stores a game program, various data, and the like which are read by the CPU 30 from the optical disk 4. With reference to FIG. 3, exemplary programs and data to be stored in the main memory 33 when the sports game of the present invention is executed are described below. FIG. 3 is a schematic memory map showing the exemplary programs and data to be stored in the main memory 33.

As shown in FIG. 3, the main memory 33 includes a program storage area 331 and a data storage area 332. Specifically, the program storage area 331 stores: a main game processing program to be executed by the CPU 30; a competition initial setting program utilized by the main game processing program; an input operation program; a competition processing program; an audience excitement factor increase/decrease program; a game character display program; an audience excitement factor gauge display program; a bonus game program; and the like. The data storage area 332 includes: an operation data buffer utilized by these programs; audience excitement factor increase/decrease data; audience excitement factor initial value data; audience supporting power data; player object ability data; bonus game setting data; and the like.

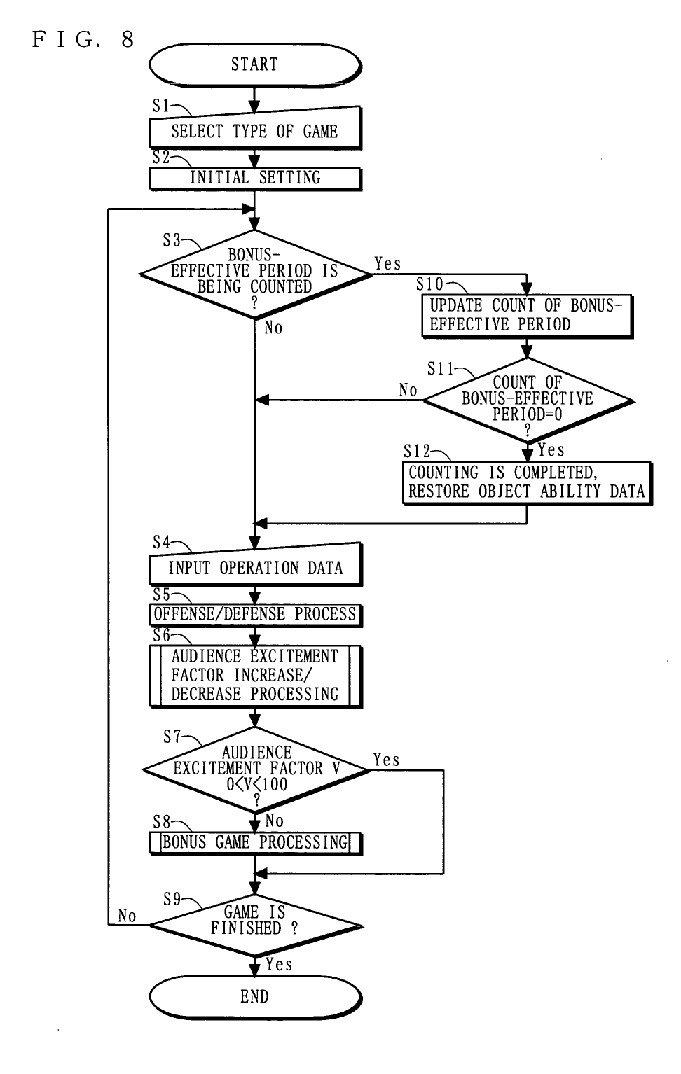

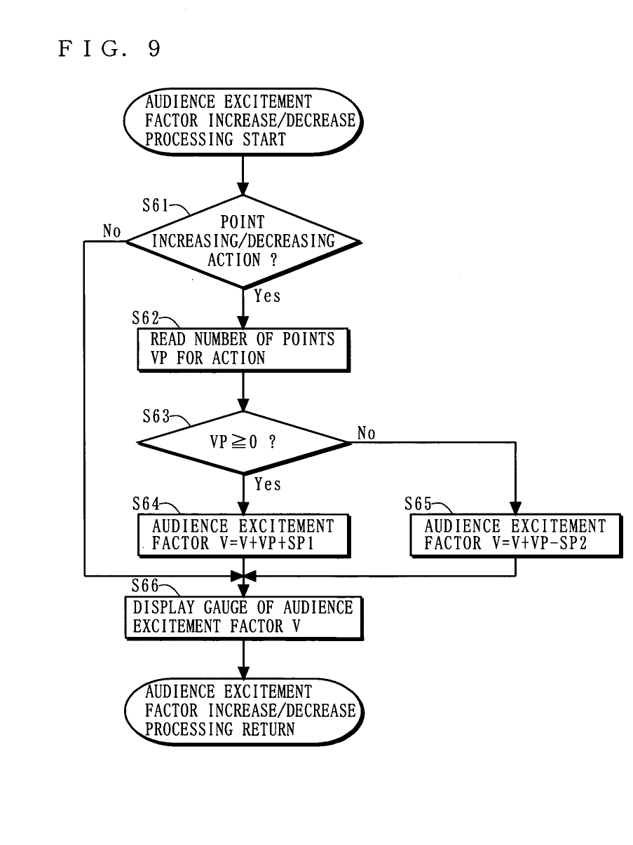

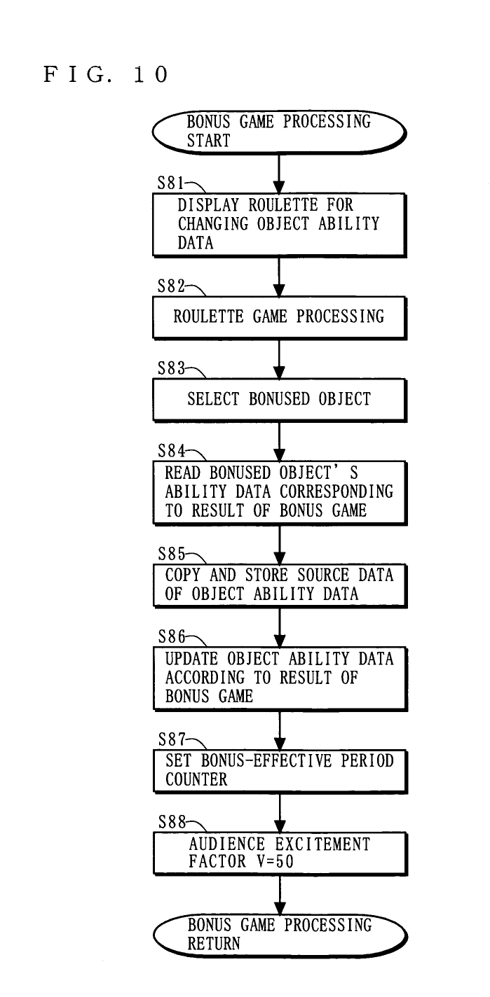

The main game processing program is a program which defines the entire game processing. When the main game processing program starts to be executed, the game processing starts (see FIG. 8). The competition initial setting program makes an initial setting as to whether a place (e.g., a stadium) at which a competitive sports game is held is “home” or “away” for the respective teams, among other initial settings (see S2 in FIG. 8). The input operation program defines the processes related to the movements of athlete characters which are performed according to operation signals from a controller 6 (see S4 in FIG. 8). The competition processing program defines the processes related to the game progression involving offense and defense of athlete characters of both teams, which are participating in the competitive sports game (see S5 in FIG. 8). The audience excitement factor increase/decrease program defines the processes of increasing or decreasing audience excitement factor in accordance with the movements of the player character or the movements of other athlete characters carrying out an offensive or defensive action (the movements of the player character or the other athlete characters are hereinafter simply referred to as “actions of characters”) (see S61 to S65 in FIG. 9). The movements of the other athlete characters are to be controlled by the competition processing program. The game character display program defines the processes of making displays on a game screen in accordance with the operations of the player character or the like (seeS5 in FIG. 8). The audience excitement factor gauge display program defines the processes of displaying on the game screen an audience excitement factor gauge which varies according to the change of audience excitement factor (see S66 in FIG. 9). The bonus game program defines a bonus game which is executed when the audience excitement factor satisfies a predetermined requirement (see S8 in FIG. 8). The bonus game is different from the competitive sports game.

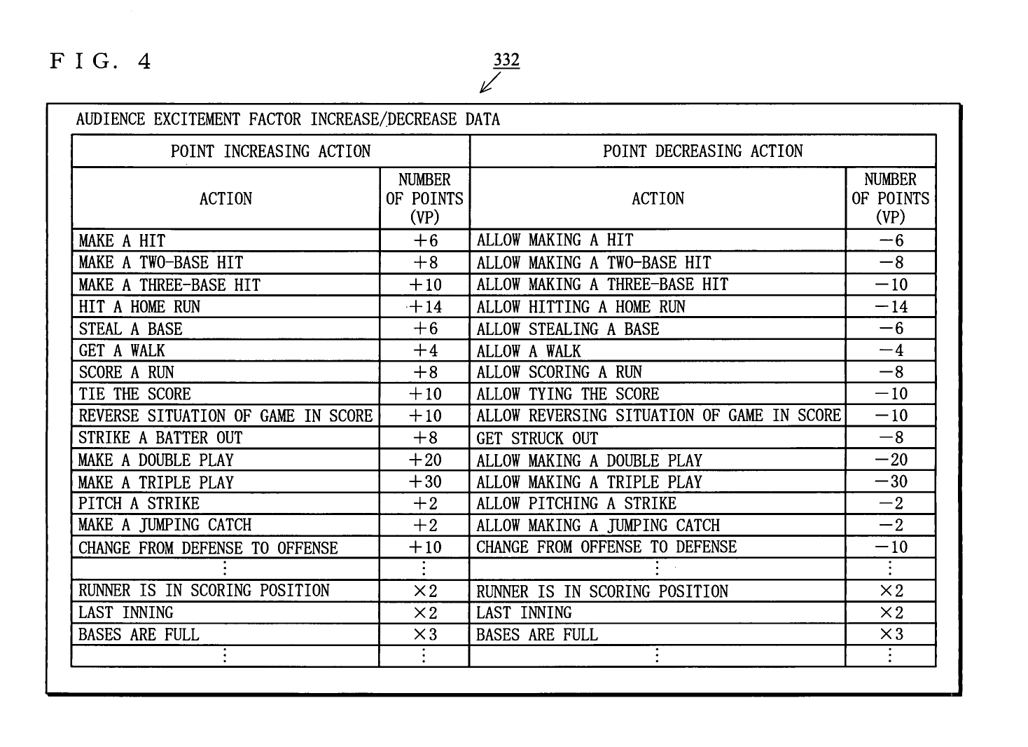

In the operation data buffer, operation signals from the aforementioned controller 6 are temporarily stored. The audience excitement factor increase/decrease data describes the actions which cause an increase or decrease of audience excitement factor and the associated numbers of points. The audience excitement factor increase/decrease data is utilized by the aforementioned audience excitement factor increase/decrease program. With reference to FIG. 4, exemplary audience excitement factor increase/decrease data is described below. Note that FIG. 4 illustrates exemplary audience excitement factor increase/decrease data in the case where the competitive sports game is a baseball game.

As shown in FIG. 4, the audience excitement factor increase/decrease data defines actions which cause an addition or reduction of points VP and the corresponding numbers of points VP to be added or reduced. The points VP are used when calculating the value of the audience excitement factor. The value of the audience excitement factor is calculated by adding or reducing those points VP one after another (the details of the audience excitement factor are described further below). The numbers of points VP defined in the audience excitement factor increase/decrease data are described in terms of actions of one of the two teams participating in the competitive sports game (e.g., “Player 1”'s team, whose member athletes are to be operated by a player operating the controller 6a). “Player 1” 's team, which refers to one of the two teams participating in the competitive sports game, is hereinafter referred to as “player's team.”

Specifically, the audience excitement factor increase/decrease data describes the numbers of points VP by which the value of the audience excitement factor of the player's team increases when an athlete of the player's team conducts an action that amounts to a successful offensive against an opponent team (which refers to the other of the two teams participating in the competitive sports game). Greater increases of points VP are defined for actions which are more beneficial to the player's team. For example, if an athlete character of the player's team “makes a hit,” which amounts to a successful offensive against the opponent team, the value of the audience excitement factor of the player's team increases by six points VP (points VP=+6). If an athlete character of the player's team makes an offensive action which causes big damage to the opponent team and which excites the audience in support of the player's team (e.g., if an athlete character of the player's team “hits a home run” or if the player's team successfully “reverses the situation of the game in the score”), the value of the audience excitement factor of the player's team increases by a greater number of points VP (e.g., +14 or +10).

In addition, the audience excitement factor increase/decrease data describes the numbers of points VP by which the value of the audience excitement factor of the player's team increases if an athlete of the player's team conducts an action that amounts to a successful defense against the opponent team. Greater increases of points VP are defined for actions which are more beneficial to the player's team. For example, if an athlete character of the player's team “pitches a strike,” which amounts to a successful defense against the opponent team, the value of the audience excitement factor of the player's team increases by two points VP (“points VP=+2”). If an athlete character of the player's team makes a defensive action which causes big damage to the opponent team and which excites the audience in support of the player's team (e.g., if an athlete character of the player's team “makes a double play”), the value of the audience excitement factor of the player's team increases by a greater number of points VP (e.g., +20).

In addition, the audience excitement factor increase/decrease data describes the numbers of points VP by which the value of the audience excitement factor of the player's team decreases when an athlete of the player's team conducts an action that amounts to an unsuccessful defense against the opponent team. Greater decreases of points VP are defined for actions which are more beneficial to the opponent team. For example, if an athlete character of the player's team “allows making a hit (i.e., allows the opponent team to make a hit),” which amounts to an unsuccessful defense against the opponent team, the value of the audience excitement factor of the player's team decreases by six points VP (“points VP=−6”). If an athlete character of the player's team makes a defensive action which causes big damage to the player's team and which excites the audience in support of the opponent team (e.g., if an athlete character of the player's team “allows hitting a home run” or if the player's team “allows reversing the situation of the game in the score”), the value of the audience excitement factor of the player's team decreases by a greater number of points VP (e.g., −14 or −10).

In addition, the audience excitement factor increase/decrease data describes the numbers of points VP by which the value of the audience excitement factor of the player's team decreases if an athlete of the player's team conducts an action that amounts to an unsuccessful offensive against the opponent team. Greater decreases of points VP are defined for actions which are more beneficial to the opponent team. For example, if an athlete character of the player's team “allows pitching a strike,” which amounts to an unsuccessful offensive against the opponent team, the value of the audience excitement factor of the player's team decreases by two points VP (“points VP=−2”). If an athlete character of the player's team makes an offensive action which causes big damage to the player steam and which excites the audience in support of the opponent team (e.g., if an athlete character of the player's team “allows making a double play”), the value of the audience excitement factor of the player's team decreases by a greater number of points VP (e.g., −20).

Moreover, the audience excitement factor increase/decrease data describes a condition (in connection with the situation of the competitive sports game) which boosts the numbers of points VP. For example, in the situation where “a runner is in scoring position” or “the game is in the last inning” in the competitive sports game, the numbers of points VP by which the value of the audience excitement factor increases or decreases as a result of the corresponding actions thereof being made are doubled.

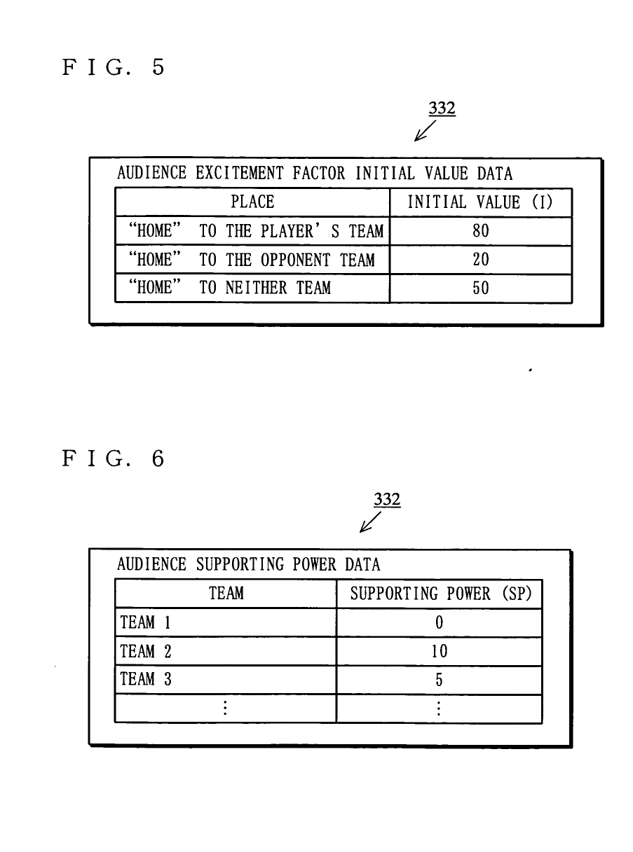

Next, with reference to FIG. 5, exemplary audience excitement factor initial value data is described. Note that FIG. 5 is a diagram showing the exemplary audience excitement factor initial value data.

As shown in FIG. 5, the audience excitement factor initial value data represents initial values I of audience excitement factor which are set depending on at which place a virtual competitive sports game is played. For example, if the competitive sports game is to be played at the home ground of the player's team, the value of the audience excitement factor of the player's team is initially set to be 80 (“initial value 1=80”). On the other hand, if the competitive sports game is to be played at the home ground of the opponent team (i.e., an “away” ground for the player's team), the value of the audience excitement factor of the player's team is initially set to be 20 (“initial value I=20”). Moreover, if the competitive sports game is to be played at a place which is not the home ground of either team, the value of the audience excitement factor of each team is initially set to be 50 (“initial value 1=50”).

Next, with reference to FIG. 6, exemplary audience supporting power data is described. FIG. 6 is a diagram showing exemplary audience supporting power data.

In FIG. 6, the audience supporting power data represents the supporting power SP of the audience, which indicate the degree of zeal of the audience (who are present at the place where the virtual competitive sports game is held) to support their favorite team. The supporting power SP is set with respect to each team. For example, in FIG. 6, the “supporting power SP=0,” the “supporting power SP=10,” and the “supporting power SP=5” are set for “Team l,” “Team 2,” and “Team 3,” respectively.

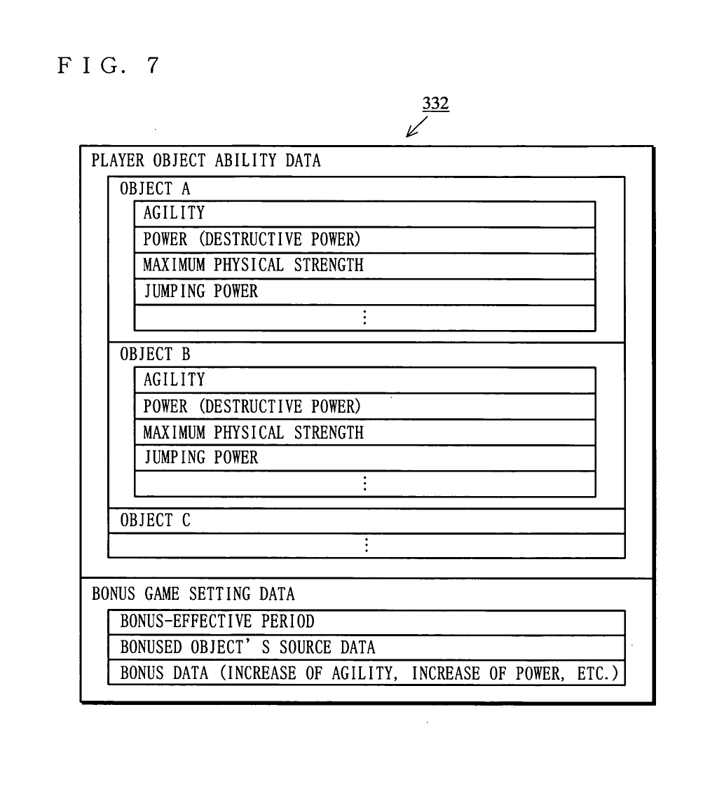

Next, with reference to FIG. 7, exemplary player object ability data and exemplary bonus game setting data are described. FIG. 7 is a diagram showing exemplary player object ability data and exemplary bonus game setting data.

In FIG. 7, the player object ability data represents abilities to be individually set for each athlete (i.e., object) of the teams participating in the virtual competitive sports game. What sorts of abilities are set depends on what sort of a sports game the competitive sports game is. Specifically, agility, power (destructive power), maximum physical strength (endurance), jumping power, and the like are set, for example. In the case of a baseball game, for example, even if a player performs the same operation, an athlete having a greater power will be able to send a ball flying farther; an athlete having a greater agility will be able to run at a higher speed between bases; an athlete having a greater physical strength will be able to show stable performance in pitching more innings; an athlete having a greater jumping power will be able to jump higher to catch a batted ball traveling over his or her head; and so on. In the competitive sports game, the operations of individual athletes are processed based on such player object ability data.

The bonus game setting data represents a bonus-effective period, bonused object's source data, and bonus data. The bonus-effective period describes a period during which the bonus (as described below) is effective. The bonused object's source data indicates the aforementioned player object ability data of a bonused object before the bonus is applied thereto. The bonus data describes what change will be made to which player object ability data (e.g., the increase of agility, the increase of power, and the like) when the bonus becomes effective.

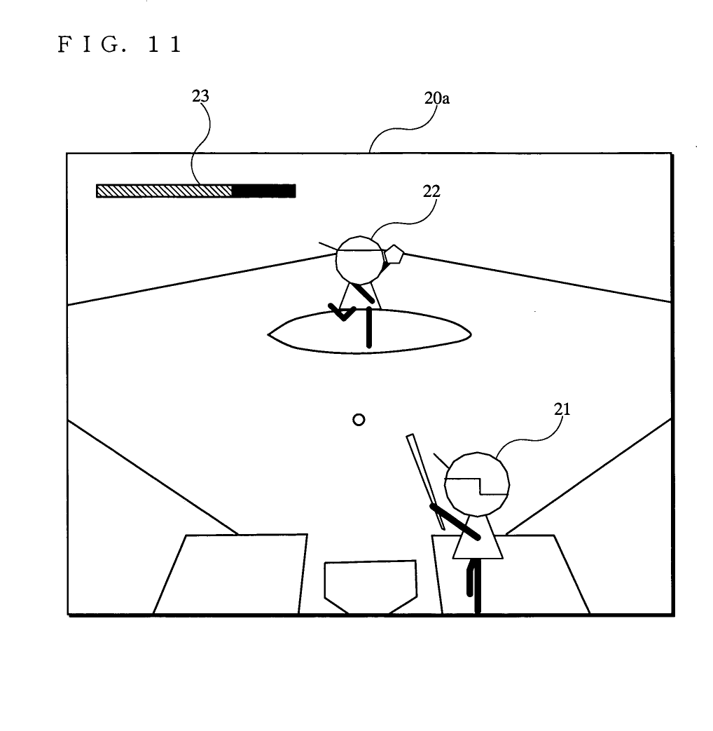

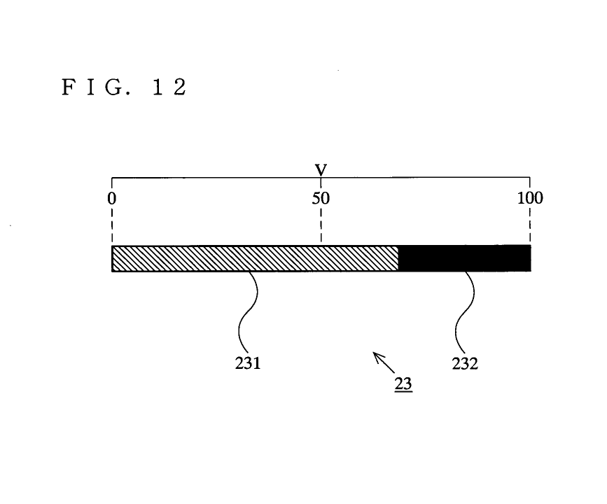

Next, with reference to FIGS. 8 to 13, the game processing executed by the game machine 3 is described. FIG. 8 is a flowchart for illustrating the overall process of the competitive sports game which is executed by the game machine 3. FIG. 9 is a subroutine for illustrating the detailed operations of step S6 in FIG. 8. FIG. 10 is a subroutine for illustrating the detailed operations of step S8 in FIG. 8. FIGS. 11 to 13 show exemplary game images which may be displayed on the monitor 2 by the game processing. These exemplary game images are given here for specifically explaining the operations of the competitive sports game processing.

If the power of the game machine 3 is turned on, the CPU 30 of the game machine 3 executes the starting program stored in the Boot Rom (not shown), and the main memory 33 and other units are initialized. Then, the game program stored in the optical disk 4 is read and loaded into the main memory 33. Thereafter, the CPU 30 starts to execute the game program, and a game image is displayed on the monitor 2. Thus, the game is started.

In FIG. 8, in response to an operation of the controller 6 by a player of the game machine 3, the type of a game for which the processing is performed is selected. At this time, in accordance with the selected type of the game, a name of a team which is to participate in a competition and a “competition place” are also selected (step S1). For example, at step S1, the type of a game is selected from among competitive sports games such as a baseball game, a soccer game, a volleyball game, and so on. The description below illustrates an exemplary case where the baseball game is selected as the competitive sports game to be performed, in order to make the description specific.

Next, the CPU 30 performs initial settings in accordance with the competitive sports game selected at the aforementioned step S1, and starts the game (step S2). Then, control proceeds to the next step. At the time of the initial settings, in addition to the initial settings for the game programs and data being performed in accordance with the competitive sports game, the initial settings for the audience excitement factor V and the supporting power SP with respect to each team are also performed. Specifically, the CPU 30 performs the initial settings with respect to both teams which are to participate in the competitive sports game, i.e., the player's team (e.g., “player 1's” team, whose member athletes are to be operated by a player operating the controller 6a) and the opponent team. Then, based on the audience excitement factor initial value data (see FIG. 5) and the “competition place” selected at the aforementioned step S1, the CPU 30 sets the audience excitement factor V so as to accord with an appropriate initial value I described by the audience excitement factor initial value data (i.e., V=1). Based on the audience supporting power data (see FIG. 6) and the name of the team selected as the player's team, the CPU 30 sets the supporting power SP1 for the player's team. Moreover, based on the audience supporting power data and the name of the team selected as the opponent team, the CPU 30 sets the supporting power SP2 for the opponent team.

Next, the CPU 30 determines whether the bonus-effective period during which the bonus is effective (as described below) is being counted (step S3). If the bonus-effective period is being counted, control proceeds to the next step S10. If the bonus-effective period is not being counted, control proceeds to the next step S4.

At step S4, an operation signal is inputted in response to an operation performed by a player on the controller 6. Then, in response to the operation signal inputted at step S4, a process relating to an offensive or defense performed in the competitive sports game (an offense/defense process) is performed (step S5). Then, control proceeds to the next step. The offense/defense process is performed based on the aforementioned competition processing program, and the corresponding offensive or defensive action is expressed on the monitor 2 as a game image. Athletes (i.e., objects) that are participating in the competitive sports game are controlled so as to move with the performance level corresponding to their player object ability data. In other words, the player object ability data, which is set with respect to each individual athlete, affects the performance of the corresponding athlete acting in the competitive sports game.

Next, the CPU 30 performs the process of increasing or decreasing the value of the audience excitement factor V based on the action (i.e., movement processed by the offense/defense process of step S5) made by an athlete (i.e., an object) of the player's team (step S6). Then, control proceeds to the next step. With reference to FIG. 9, the detailed processing performed at step S6 are described.

In FIG. 9, the CPU 30 determines whether the action performed by the athlete of the player's team which was performed by the offense/defense process corresponds to any “point increase/decrease action” by referring to the audience excitement factor increase/decrease data (see FIG. 4)(step S61). Then, if the action corresponds to any “point increase/decrease action,” control proceeds to step S62. If the action does not correspond to any “point increase/decrease action,” control proceeds to step S66.

At step S62, the CPU 30 reads the number of points VP corresponding to the action from the audience excitement factor increase/decrease data. Then, the CPU 30 determines whether the number of points VP read at step S62 is equal to or greater than zero (step S63). If the number of points VP is equal to or greater than zero, control proceeds to step S64. If the number of points VP is less than zero, control proceeds to step S65.

At step S64, the CPU 30 performs the process of increasing the value of the audience excitement factor V. Then, control proceeds to the next step S66. Specifically, the CPU 30 adds, to the current value of the audience excitement factor V, the number of points VP read at the aforementioned step S62 and the value of the supporting power SP1 for the player's team set at the aforementioned step S2. Thus, a new, increased value of the audience excitement factor V is obtained. Note that the value of the audience excitement factor V for a “home team,” whose initial value I of the audience excitement factor is large, is initially large. Further, the bigger damage an action of the player's team causes the opponent team and the more excited the audience in support of the player's team becomes due to that action, the greater points VP are added, so that the audience excitement factor V receives a greater increase. Furthermore, the larger supporting power SP the player's team enjoys, the greater increase the audience excitement factor V receives.

On the other hand, at step S65, the CPU 30 performs the process of decreasing the value of the audience excitement factor V, and then control proceeds to the next step S66. Specifically, the CPU 30 adds the number of points VP (which has a negative value) read at the aforementioned step S62 to (i.e., subtracts the absolute value of the number of points VP from) the current value of the audience excitement factor V, and then subtracts the value of the supporting power SP2 for the opponent team set at the aforementioned step S2. Thus, a new, decreased value of the audience excitement factor V is obtained. Here, the bigger damage an action of the player's team causes the player's team and the more excited the audience in support of the opponent team becomes due to that action, the greater points VP are reduced, so that the audience excitement factor V receives a greater decrease. Moreover, the larger supporting power SP the opponent team enjoys, the greater decrease the audience excitement factor V receives.

At step S66, the CPU 30 displays a voltage gauge so as to correspond to the current value of the audience excitement factor V in a game image on the monitor 2. Then, the processes of the present subroutine are completed. With reference to FIG. 11 and FIG. 12, an exemplary game image displayed on the monitor 2 is described below. FIG. 11 is the exemplary game image 20a displayed on the monitor 2, and FIG. 12 is an enlarged view of the voltage gauge 23 displayed on the game image 20a of FIG. 11.

In FIG. 11, a baseball game (as a competitive sports game) is expressed on the game image 20a. The player's team is playing offense, and the opponent team is playing defense. An athlete of the player's team and an athlete of the opponent team are expressed respectively as an object 21 and an object 22. In the upper left corner of the game image 20a, the voltage gauge 23 is displayed.

As shown in FIG. 12, in the voltage gauge 23, an area (i.e., the area shaded by oblique lines in FIG. 12) 231 for indicating the value of the audience excitement factor V1 for the player's team is displayed from the left end of the voltage gauge 23. An area (i.e., the painted-out area in FIG. 12) 232 for indicating the value of the audience excitement factor V2 for the opponent team is displayed from the right end of the voltage gauge 23 so as to be in contact with the other area 231. Thus, the voltage gauge 23 is displayed so as to be divided between the areas 231 and 232.

In the voltage gauge 23, the audience excitement factor V is set in the horizontal direction. At the left end of the voltage gauge 23, the audience excitement factor V has the value of zero (i.e., the audience excitement factor V=0). At the right end of the voltage gauge 23, the audience excitement factor V has the value of one hundred (i.e., the audience excitement factor V=100). At the middle of the voltage gauge 23, the audience excitement factor V has the value of fifty (i.e., the audience excitement factor V=50). The border between the area 231 and the area 232 moves along the horizontal direction of the voltage gauge 23 based on the value of the audience excitement factor V calculated at the aforementioned step S64 or S65. When the audience excitement factor V has the value of more than one hundred, only the area 231, which indicates the audience excitement factor V1, is displayed on the voltage gauge 23 so as to extend throughout the whole length thereof. When the audience excitement factor V has the value of less than zero, only the area 232, which indicates the audience excitement factor V2, is displayed on the voltage gauge 23 so as to extend throughout the whole length thereof.

The audience excitement factor V1 and the audience excitement factor V2, which are expressed by the voltage gauge 23, are indicated by the lengths of the area 231 and the area 232 respectively along the horizontal direction. The length of the area 231 (indicating the audience excitement factor V1) plus the length of the area 232 (indicating the audience excitement factor V2) always equals the length of the voltage gauge 23 (i.e., V1+V2=100). The length of the area 231, which indicates the audience excitement factor V1 for the player's team, is determined based on the value of the audience excitement factor V calculated at the aforementioned step S64 or S65 (i.e., V1=V). In short, because the value of the audience excitement factor V is calculated based on an action of the player's team as described above, the value of the audience excitement factor V itself is set as the value of the audience excitement factor V1 for the player's team. Meanwhile, the length of the area 232, which indicates the audience excitement factor V2 for the opponent team, is determined according to the length of the area 231, which indicates the audience excitement factor V1 (i.e., V2=100⊕V1=100−V). This means that the value of the audience excitement factor V1 plus the value of the audience excitement factor V2 is always one hundred. Therefore, if the value of the audience excitement factor V1 increases, the value of the audience excitement factor V2 decreases, whereas if the value of the audience excitement factor V1 decreases, the value of the audience excitement factor V2 increases.

As shown in FIG. 4, the audience excitement factor increase/decrease data describes the actions in terms of the player's team. However, the actions of the player's team are always closely connected with those of the opponent team. For example, if the player's team experiences an action of “allow making a hit,” it means that the opponent team experiences an action of “make a hit” at the same time. In other words, if the player's team experiences an action of “allow making a hit,” whereby the value of the audience excitement factor V1 decreases by six (points VP=−6), it also means that the opponent team experiences an action of “make a hit,” whereby the value of the audience excitement factor V2 increases by six (points VP=+6). Therefore, it is possible to adopt a manner of calculation in which the audience excitement factor V1 and the audience excitement factor V2 are calculated separately. In this case, the audience excitement factor increase/decrease data would describe only the actions which cause an increase of points VP. In the present invention, however, a manner of calculation is adopted where the value of the audience excitement factor V is calculated based on only the actions of the player's team, which in effect involves the calculation of the audience excitement factor V2 for the opponent team.

Referring back to FIG. 8, after the audience excitement factor increase/decrease processing of step S6 is completed, the CPU 30 determines whether the current value of the audience excitement factor V is within the range of from zero to one hundred (i.e., 0<V<100)(step S7). If the current value of the audience excitement factor V is within the range of from zero to one hundred, control proceeds to step S9. If the current value of the audience excitement factor V is equal to or less than zero (i.e., V≦0), or is equal to or greater than one hundred (i.e., 100≦V), control proceeds to step S8.

At step S8, the CPU 30 performs the bonus game processing. Then, control proceeds to step S9. This bonus game is a game different from the aforementioned competitive sports game, and the result of the bonus game affects the subsequent development of the competitive sports game. With reference to FIG. 10, the detailed processes to be performed at this step S8 are described.

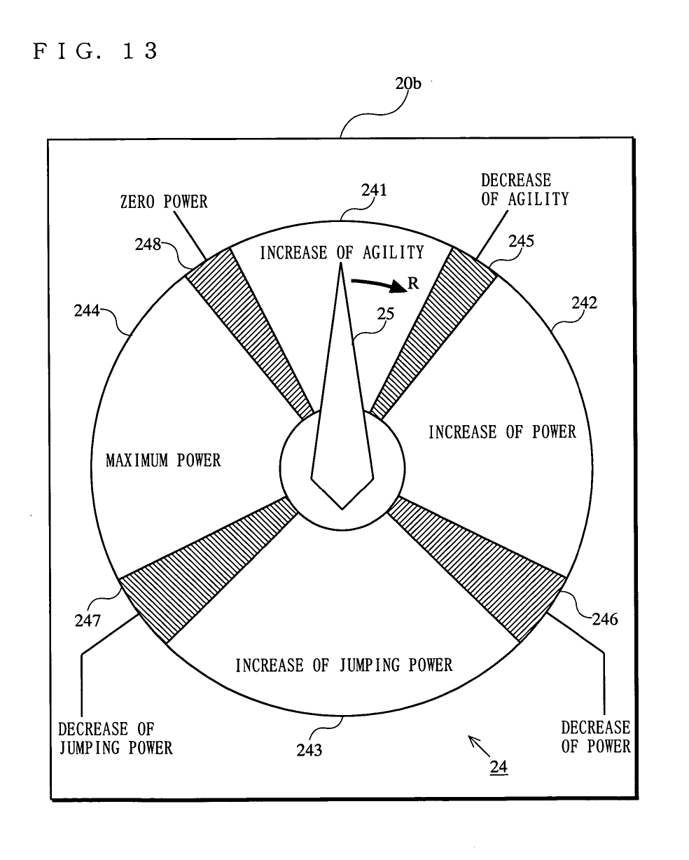

As shown in FIG. 10, the CPU 30 displays, as a game image for the bonus game, a roulette on the monitor 2 (step S81). Then, control proceeds to the next step S82. The result of the bonus game using the roulette determines how the player object ability data is changed with respect to an athlete (i.e., an object) of either one of the two teams participating in the competitive sports game. With reference to FIG. 13, the game image 20b for the bonus game is described below. FIG. 13 is an exemplary game image 20b to be displayed for the bonus game in the case where a roulette game is adopted as the bonus game.

As shown in FIG. 13, a circular roulette 24 is displayed as the game image 20b for the bonus game. The roulette 24 has a “roulette pointers” object 25, which rotates in the R (shown) direction on the central point of the circular roulette, the central point serving as the axis of rotation. The roulette 24 is divided into a plurality of areas 241 to 248 along the circular direction. In each of the areas 241 to 248, a description indicating how the player object ability data may change is provided. Specifically, the description provided in an area (i.e., one of the areas 241 to 248) at which the tip of the “roulette pointer” object 25 stops is determined as the result of the bonus game. For example, in areas 241 to 244 are provided descriptions indicating the change of the player object ability data involving the increase of a player object ability. Specifically, “Increase of Agility” is provided to the area 241, “Increase of Power” is provided to the area 242, “Increase of Jumping Power” is provided to the area 243, and “Maximum Power” is provided to the area 244. To areas 245 to 248 (i.e., the areas shaded by oblique lines in FIG. 13) are provided descriptions indicating the change of the player object ability data involving the decrease of a player object ability. Specifically, “Decrease of Agility” is provided to the area 245, “Decrease of Power” is provided to the area 246, “Decrease of Jumping Power” is provided to the area 247, and “Zero Power” is provided to the area 248. Each of the areas 241 to 244, where descriptions indicating the change of the player object ability data involving the increase of a player object ability are provided, is larger than any one of the areas 245 to 248, where descriptions indicating the change of the player object ability data involving the decrease of a player object ability are provided. The type of description to be provided in each area, the extent of each area, and the number and arrangement of areas are determined at random, based on the aforementioned bonus game program and the aforementioned bonus game setting data. In addition, data whose value may be increased or decreased as a result of the bonus game is not restricted to the player object ability data. For example, weather in the virtual game space where the competitive sports game is held may be changed as a result of the bonus game. Or a particular athlete may become capable of performing an overwhelming special action which will cause big damage to the opponent team.

Referring back to FIG. 10, the CPU 30 performs the processing of the roulette game as the bonus game (step S82). Then, control proceeds to the next step. In the processing of the roulette game, the “roulette pointer” object 25, which rotates in the R direction on the aforementioned axis of rotation, is caused to stop in response to an operation signal from the controller 6. Then, the description provided in the area (i.e., one of the areas 241 to 248) pointed by the tip of the stopped “roulette pointer” object 25 will be determined as the result of the bonus game. Here, the right to execute the roulette game is held by a team whose audience excitement factor V1 or V2 has exceeded a predetermined threshold value. Specifically, if the value of the audience excitement factor V is equal to or greater than one hundred (i.e., 100≦V) at the aforementioned step S7, the CPU 30 determines that the value of the audience excitement factor V1 has reached or exceeded a threshold value “100,” and then grants the right to execute the roulette game to the player who operates the player's team. Meanwhile, if the value of the audience excitement factor V is equal to or less than zero (i.e., V≦0) at the aforementioned step S7, the CPU 30 determines that the value of the audience excitement factor V2 has reached or exceeded the threshold value “100,” and then grants the right to execute the roulette game to a player who operates the opponent team. In other words, the right to execute the bonus game is granted to one team when the value of the audience excitement factor (i.e., V1 or V2) for that team has reached or exceeded a predetermined value. Within the areas 241 to 248 included in the roulette 24, each of the areas 241 to 244 (in which the descriptions indicating the change of the player object ability data involving the increase of a player object ability are provided) is arranged so as to be larger than any one of the remaining other areas. Accordingly, the roulette game is a game by playing which the ability of an athlete of the bonus game player will increase with a high probability. This therefore means that if the audience excitement factor for one team reaches or exceeds a predetermined value (i.e., voltage), the player operating that team acquires the right to execute the bonus game by playing which the ability of an athlete of the team of the player will increase with a high probability. In the case where the competitive sports game is played by a human player and the computer, if the right to execute the roulette game is granted to the computer side, the game processing is performed by the CPU 30 stopping the “roulette pointer” object 25 at random.

Next, the CPU 30 selects a “bonused object” (step S83). Then, control proceeds to the next step. The “bonused object” refers to an object (i.e., an athlete) to which the result of the bonus game (i.e., the roulette game processing, which has been performed at the aforementioned step S82) should be applied. The “bonused object” is selected from among the athletes of the team which has the right to execute the roulette game. All athletes belonging to the team may be simultaneously determined as “bonused objects.” Alternatively, only the athlete(s) (e.g., a batter and a pitcher) appearing on a current game image 20a may be determined as the “bonused objects.” Further alternatively, the “bonused object(s)” may be selected at random.

Next, the CPU 30 reads a particular field of the player object ability data of the “bonused object” selected at the aforementioned step S83, the particular field being determined based on the result of the bonus game obtained at the aforementioned step S82 (step S84). The CPU 30 copies and stores, as source data, the data in the particular field of the player object ability data in the data storage area 332 (step S85). Then, based on the result of the bonus game, the CPU 30 overwrites (i.e., updates) the player object ability data of the “bonused object” (step S86). Then, control proceeds to the next step. Here, if the result of the bonus game is one that requires the value of the player object ability data to be increased, the data obtained by the updating is player object ability data in which the value thereof is increased as compared with the source data. If the result of the bonus game is one that requires the value of the player object ability data to be decreased, the data obtained by the updating is player object ability data in which the value thereof is decreased as compared with the source data. The value by which the player object ability data is increased or decreased may be determined at random. For example, the value of the player object ability data may be increased or decreased at a steady rate or by a steady value.

Next, the CPU 30 sets a “bonus-effective period counter” (step S87), and changes the value of the audience excitement factor V to 50 (step S88). Then, the processes of the present subroutine are completed. The “bonus-effective period counter” is a counter for counting the bonus-effective period in the bonus game setting data. The “bonus-effective period counter” monitors the bonus-effective period during which the updated player object ability data obtained at step S86 is effective.

Referring back to FIG. 8, at step S9, the CPU 30 determines whether the competitive sports game, which is currently being processed, should be finished. If the competitive sports game is to continue to be in execution, the CPU 30 continues to perform the game processing (i.e., control returns back to step S3). If the competitive sports game is to be finished, the game processing according to the present flowchart is completed.

If the “bonus-effective period counter” set at the aforementioned step S87 is counting the bonus-effective period, control proceeds from the aforementioned step S3 to step S10. Then, the CPU 30 updates the counted value of the bonus-effective period indicated by the “bonus-effective period counter” (step S10), and determines whether the counted value of the bonus-effective period is zero (step S11). That the counted value of the bonus-effective period is zero means that the bonus-effective period during which the updated player object ability data is effective has elapsed after the bonus-effective period counter was set at the aforementioned step S87. If the counted value of the bonus-effective period is not zero, control proceeds to the aforementioned step S4. If the counted value of the bonus-effective period is zero, control proceeds to the next step S12.

At step S12, the CPU 30 completes the counting of the bonus-effective period by the “bonus-effective period counter,” and writes the source data (which was copied and stored in the data storage area 332 at the aforementioned step S85) back to the original address (i.e., the location at which the ability data overwritten at the aforementioned step S86 was placed) in the player object ability data. Then, control proceeds to the aforementioned step S4. At this step S12, the bonus-effective period is terminated, and the value of the ability data of the athlete (i.e., object) which was changed as a result of the bonus game is restored to the original value before the bonus game was executed.

As described above, a game machine according to the embodiment of the present invention realizes game playing in which the enjoyment arising from playing the game is enhanced by allowing the state of a third party, which is different from the athletes of each team (i.e., the subjects of the competitive game in a virtual game space), to affect development of the game. Specifically, the concept of audience's voltage (audience excitement) is introduced into the game as the state of the third party, whereby the relationship between athletes and audience is allowed to be involved in the development of the game. By increasing the audience's voltage, a player is allowed to play a different game (i.e., a bonus game), which will with a high probability result in granting the player an advantage in the game. Thus, the enjoyment arising from playing the competitive game is enhanced.

In the above, the description has been made taking a competitive sports game for example. However, the game which can be applied to the present invention is not restricted to a competitive sports game. Needless to say, the present invention can be applied to any game in which game characters participating in a competition are divided into at least two groups.

The embodiment described above has illustrated an exemplary case where an optical disk is used as an information storage medium for storing a game program or the like. However, other types of storage media may be used for storing the game program of the present invention. For example, in the case where the game program of the present invention is subjected to processing in a hand-held or non-handheld type game machine, a game cartridge or the like in which the game program is stored may be used. In this case, the game program stored in the game cartridge is read by the game machine, whereby a similar processing is performed. Further, the game program may be provided to the game machine via another sort of medium or a communication line.

While the invention has been described in detail, the foregoing description is in all aspects illustrative and not restrictive. It is understood that numerous other modifications and variations can be devised without departing from the scope of the invention.

1. A game machine for expressing, on a game screen, a competitive game played between character objects which are divided into two sides, comprising:
operation means for inputting operation data in response to an operation by a player of the game machine;
game processing means for processing the competitive game by allowing a character object participating in the competitive game to make actions in response to the operation data inputted from the operation means;
action point storage means for storing a number of points which is set with respect to each action of the character object and which indicates a degree to which a state of at least one of a plurality of third parties is affected when the action is made by the character object, the affected third party being associated with one of the two sides participating in the competitive game, and the plurality of third parties being different from the character objects participating in the competitive game;
third party's state calculation means for, in accordance with an action of the character object as controlled by the game processing means, reading from the action point storage means the number of points for the action and calculating, based on the number of points, a new state of the affected third party and a new state of a further third party associated with the other of the two sides participating in the competitive game; and
game presenting means for, if the state of either third party reaches a predetermined value, presenting a further game, the further game being exclusive to a player operating the side associated with the third party.

2. The game machine according to claim 1, further comprising:
gauge generation means for generating a gauge for indicating the states of the third parties associated with the two sides participating in the competitive game, the states of the third parties having been processed by the third party's state calculation means; and
display control means for controlling a display of a game image including the gauge generated by the gauge generation means, based on a result of processing of the competitive game by the game processing means.

3. The game machine according to claim 2, wherein,
the gauge generation means generates the gauge so that an entire area of the gauge is divided into two areas, each area corresponding to the state of the third party associated with a different one of the two sides, and
if the state of either third party reaches the predetermined value, the entire area of the gauge becomes the area corresponding to the state of the third party.

4. The game machine according to claim 1, wherein,
the competitive game expressed on the game screen is a virtual competitive sports game;
the character objects comprise athlete objects belonging to one of the two sides participating in the competitive sports game, and athlete objects belonging to the other of the two sides;
the states of the third parties associated with the two sides participating in the competitive game comprise an audience excitement factor for the one side and an audience excitement factor for the other side; and
if the audience excitement factor for the one side reaches or exceeds the predetermined value, the game presenting means presents the further game, the further game being exclusive to a player operating the athlete objects belonging to the one side.

5. The game machine according to claim 4, further comprising excitement factor initial value storage means for storing an initial value of the audience excitement factor for at least one of the two sides, the initial value being set dependent on a virtual playing field on which the competitive sports game is held.

6. The game machine according to claim 5, wherein,
the action point storage means stores: a number of points by which the audience excitement factor is increasable and which is associated with an action of the athlete object that produces an advantageous effect to one of the two sides to which the athlete object belongs in the competitive sports game; and a number of points by which the audience excitement factor is decreasable and which is associated with an action of the athlete object that produces a disadvantageous effect to one of the two sides to which the athlete object belongs in the competitive sports game, and
in accordance with an action of the athlete object as processed by the game processing means, the third party's state calculation means calculates the audience excitement factor through cumulatively making an addition or reduction of the number of points stored in the action point storage means to or from the initial value of the audience excitement factor stored in the excitement factor initial value storage means.

7. The game machine according to claim 4, wherein,
the further game executed by the game presenting means is a bonus game for determining a manner in which at least one of a plurality of ability values each defining skill of the athlete object participating in the competitive sports game is updated, and
the game processing means processes the competitive sports game in response to the operation data inputted from the operation means, while controlling the athlete object so as to act with a performance level corresponding to the at least one ability value as updated as a result of the bonus game.

8. The game machine according to claim 7, wherein the bonus game is a game in which the at least one ability value of an athlete object belonging to one of the two sides that is entitled to playing the bonus game will increase with a high probability.

9. The game machine according to claim 7, further comprising bonus-effective period setting means for setting an effective period during which the at least one ability value as updated is kept effective by the game processing means,
wherein, if the effective period set by the bonus-effective period setting means has elapsed, the game processing means restores the at least one ability value to the value before the update, whereafter the athlete object comes to be controlled so as to act with a performance level corresponding to the at least one ability value as restored.

10. A storage medium storing a game program to be executed by a computer in a game machine for realizing a competitive game played between character objects which are divided into two sides, the game machine including operation means for inputting operation data in response to an operation by a player of the game machine and storage means for temporarily storing data,
wherein the storage means stores a number of points which is set with respect to each action of a character object participating in the competitive game and which indicates a degree to which a state of at least one of a plurality of third parties is affected when the action is made by the character object, the affected third party being associated with one of the two sides participating in the competitive game, and the plurality of third parties being different from the character objects participating in the competitive game,
the game program causing the computer to perform:
a game processing step of processing the competitive game by allowing a character object participating in the competitive game to make actions in response to the operation data inputted from the operation means;
a third party's state calculation step of, in accordance with an action of the character object as controlled by the game processing step, reading from the storage means the number of points for the action and calculating, based on the number of points, a new state of the affected third party and a new state of a further third party associated with the other of the two sides participating in the competitive game; and
a game presenting step of, if the state of either third party reaches a predetermined value, presenting a further game, the further game being exclusive to a player operating the side associated with the third party.

11. The storage medium storing the game program according to claim 10, wherein the game program further causes the computer to perform:
a gauge generation step of generating a gauge for indicating the states of the third parties associated with the two sides participating in the competitive game, the states of the third parties having been processed by the third party's state calculation step; and
a display control step of controlling a display of a game image including the gauge generated by the gauge generation step, based on a result of processing of the competitive game by the game processing step.

12. The storage medium storing the game program according to claim 11, wherein,
the gauge generation step generates the gauge so that an entire area of the gauge is divided into two areas, each area corresponding to the state of the third party associated with a different one of the two sides, and
if the state of either third party reaches the predetermined value, the entire area of the gauge becomes the area corresponding to the state of the third party.

13. The storage medium storing the game program according to claim 10, wherein,
the competitive game expressed on the game screen is a virtual competitive sports game;
the character objects comprise athlete objects belonging to one of the two sides participating in the competitive sports game, and athlete objects belonging to the other of the two sides;
the states of the third parties associated with the two sides participating in the competitive game comprise an audience excitement factor for the one side and an audience excitement factor for the other side; and
if the audience excitement factor for the one side reaches or exceeds the predetermined value, the game presenting step presents the further game, the further game being exclusive to a player operating the athlete objects belonging to the one side.

14. The storage medium storing the game program according to claim 13, wherein,
the storage means further stores an initial value of the audience excitement factor for at least one of the two sides, the initial value being set dependent on a virtual playing field on which the competitive sports game is held;
as the number of points, the storage means stores a number of points by which the audience excitement factor is increasable and which is associated with an action of the athlete object that produces an advantageous effect to one of the two sides to which the athlete object belongs in the competitive sports game, and a number of points by which the audience excitement factor is decreasable and which is associated with an action of the athlete object that produces a disadvantageous effect to one of the two sides to which the athlete object belongs in the competitive sports game; and
in accordance with an action of the athlete object as processed by the game processing step, the third party's state calculation step calculates the audience excitement factor through cumulatively making an addition or reduction of the number of points stored in the storage means to or from the initial value of the audience excitement factor stored in the storage means.

15. The storage medium storing the game program according to claim 13, wherein,
the further game executed by the game presenting step is a bonus game for determining a manner in which at least one of a plurality of ability values each defining skill of the athlete object participating in the competitive sports game is updated, and
the game processing step processes the competitive sports game in response to the operation data inputted from the operation means, while controlling the athlete object so as to act with a performance level corresponding to the at least one ability value as updated as a result of the bonus game.

16. The storage medium storing the game program according to claim 15, wherein the bonus game is a game in which the at least one ability value of an athlete object belonging to one of the two sides that is entitled to playing the bonus game will increase with a high probability.

17. The storage medium storing the game program according to claim 15, wherein,
the game program further causes the computer to perform a bonus-effective period setting step of setting an effective period during which the at least one ability value as updated is kept effective by the game processing step,
if the effective period set by the bonus-effective period setting step has elapsed, the game processing step restores the at least one ability value to the value before the update, whereafter the athlete object comes to be controlled so as to act with a performance level corresponding to the at least one ability value as restored.
